(19) United States
(12) Patent Application Publication
(10) Pub. No.: US 2018/0097388 A1
(43) Pub. Date: Apr. 5, 2018

(54) ELECTRIC GENERATING SYSTEM

(71) Applicant: Chiung-Hao CHEN, Tainan City (TW)

(72) Inventors: Chiung-Hao CHEN, Tainan City (TW); Hsin-Hung LIU, Tainan City (TW)

(21) Appl. No.: 15/624,443

(22) Filed: Jun. 15, 2017

(30) Foreign Application Priority Data
Oct. 5, 2016 (TW) 105215103

(51) Int. Cl. H02J 7/00; H02K 7/00

(52) U.S. Cl. CPC H02J 7/0068; H02K 7/003

(57) ABSTRACT

An electric generating system includes an electric generator, a driver, an electric power supply, an electric power storage device, a discharging switch, a charging switch and an electric power switch unit. The electric power supply supplies electric power to the driver to operate the electric generator to generate electric power. The electric power switch unit switches between a first mode, where the electric power switch unit charges the electric power storage device and controls the discharging switch to transmit electric power to the electric power supply, and a second mode, where operation of the discharging switch is stopped, and the electric power switch unit simultaneously charges the electric power supply and the charging switch.

### CROSS-REFERENCE TO RELATED APPLICATION

This application claims priority of Taiwanese Utility Model Application No. 105215103, filed on Oct. 5, 2016.

### FIELD

The disclosure relates to an electric generating system, and more particularly to an electric generating system including a wire tray unit and a magnetic plate unit.

### BACKGROUND

With the rising concerns over environmental protection, renewable energy has recently attracted much attention. Common types of renewable energy are solar, hydraulic, wind power, etc. However, it is impractical to seek electric power generation using renewable energy for countries lacking such resource.

A conventional electric generating system including a wire tray unit and a magnetic unit is often used for electrical power generation. The wire tray unit and the magnetic unit are alternatively arranged along an axis, and the rotation of the wire tray unit and the magnetic unit results in electrical power generation due to electromagnetic induction. The conventional electric generating system can be optimized by adjusting the numbers of the wire tray unit and the magnetic unit, the number of the magnets in the magnetic unit, the magnetic flux density of each of the magnets, and the design of the coils of the wire tray unit. Therefore, it is desirable to further optimize the performance of the conventional electric generating system.

### SUMMARY

Therefore, an object of the present disclosure is to provide an electric generating system with improved performance.

According to an aspect of the present disclosure, an electric generating system includes an electric generator, a driver, an electric power supply, an electric power storage device, a discharging switch, a charging switch and an electric power switch unit.

The electric generator includes a wire tray unit and a magnetic plate unit. The driver is connected to the electric generator. The electric power supply is electrically connected to the driver. The discharging switch is electrically connected to the electric power storage device and the electric power supply. The charging switch is electrically connected to the electric power storage device. The electric power switch unit is electrically connected to the wire tray unit, the charging switch and the electric power supply.

The electric power supply is operable to supply a driving electric power to the driver to drive relative rotation of the wire tray unit and the magnetic plate unit such that the wire tray unit generates an electric power induced by the relative rotation of the wire tray unit and the magnetic plate unit.

The electric power switch unit is operable to switch between a first mode and a second mode.

In the first mode, the electric power switch unit supplies the electric power generated by the wire tray unit to the charging switch such that the charging switch transmits the electric power to the electric power storage device so that the electric power storage device stores the electric power. Moreover, in the first mode, the electric power switch unit controls the discharging switch to transmit the electric power stored in the electric power storage device to the electric power supply such that the electric power supply supplies the driving electric power to the driver.

In the second mode, the electric power switch unit controls the discharging switch to stop supplying the electric power stored in the electric power storage device to the electric power supply. Moreover, in the second mode, the electric power switch unit transmits a portion of the electric power generated by the wire tray unit to the electric power supply and another portion of the electric power generated by the wire tray unit to the charging switch.

### BRIEF DESCRIPTION OF THE DRAWINGS

Other features and advantages of the present disclosure will become apparent in the following detailed description of the embodiment with reference to the accompanying drawings, of which:

FIG. 1 is a schematic view of an embodiment of an electric generating system according to the present disclosure;

FIG. 2 is a partly exploded perspective view of an electric generator of the embodiment; and

FIG. 3 is a schematic block diagram of the embodiment.

### DETAILED DESCRIPTION

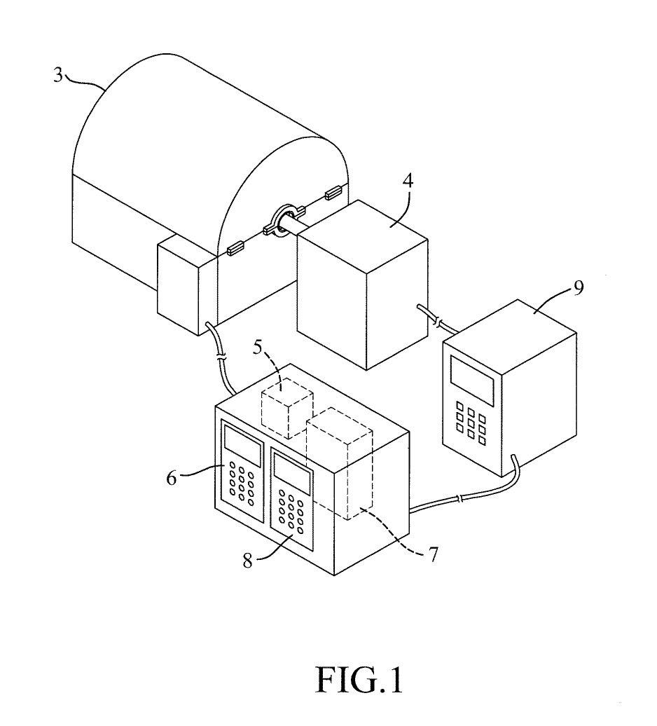

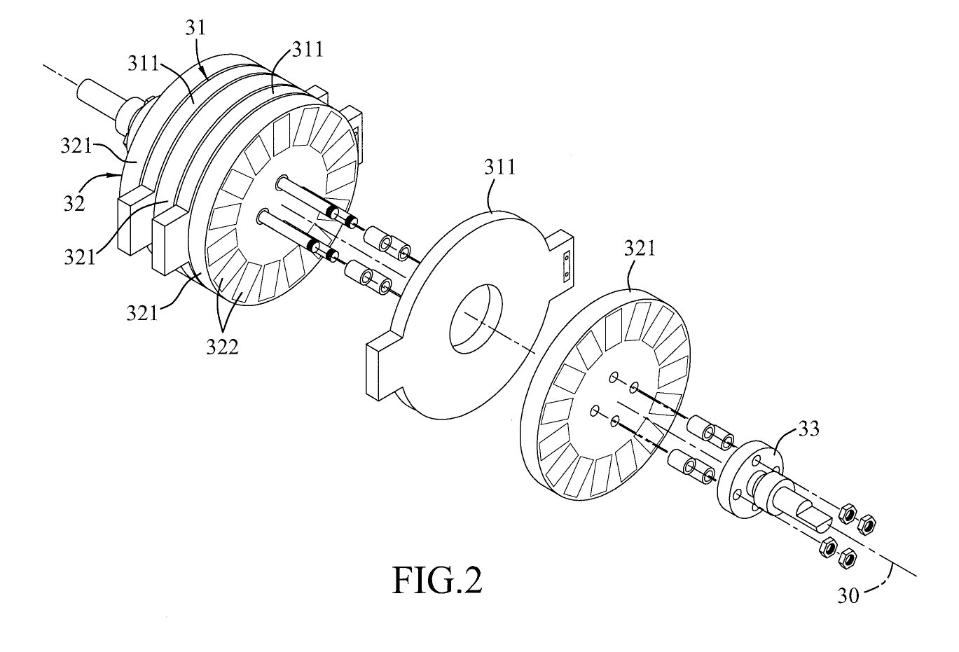

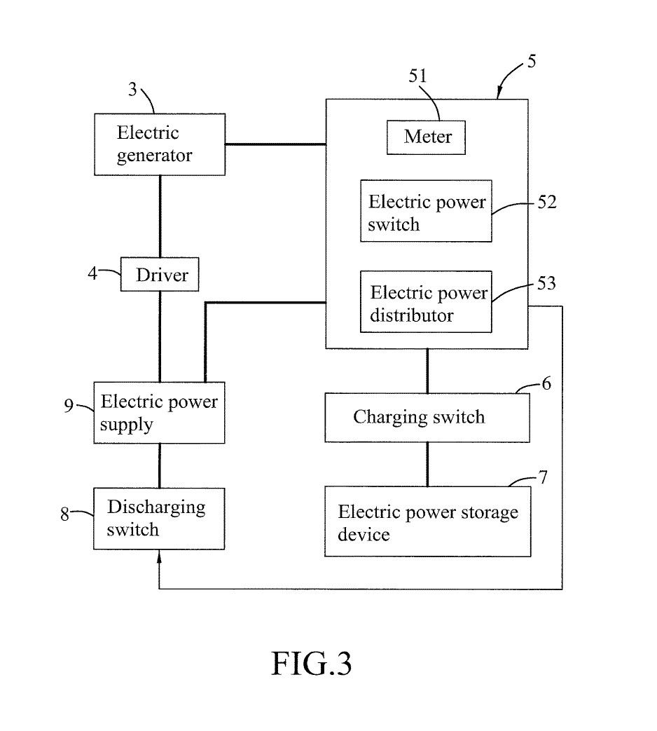

Referring to FIGS. 1, 2 and 3, an embodiment of an electric generating system according to the present disclosure includes an electric generator 3, a driver 4, an electric power switch unit 5, a charging switch 6, an electric power storage device 7, a discharging switch 8 and an electric power supply 9.

The driver 4 is connected to the electric generator 3 for driving power generation of the electric generator 3. Specifically, the electric generator 3 includes a wire tray unit 31, a magnetic plate unit 32 and a transmission shaft 33. The transmission shaft 33 extends along an axis 30 and is co-rotatably connected to the magnetic plate unit 32. The driver 4 is connected to the transmission shaft 33 and is operable to drive rotation of the transmission shaft 33. In certain embodiments, the wire tray unit 31 includes two wire trays 311 respectively disposed at opposite sides of a magnetic plate 321 of the magnetic plate unit 32. In certain embodiments, the magnetic plate unit 32 includes a plurality of magnetic plates 321 co-rotatably connected to the transmission shaft 33. The wire tray unit 31 includes a plurality of wire trays 311. The magnetic plates 321 and the wire trays 311 are alternatively arranged along the axis 30. It should be noted that the numbers and arrangement of the wire trays 311 and the magnetic plates 321 may be changed according to practical requirements.

Each of the wire trays 311 includes a plurality of coils (not shown) that generate an electric power induced by the change of magnetic field caused by rotation of adjacent magnetic plates 321. Each of the magnetic plates 321 includes a plurality of magnets 322 disposed around the axis 30.

The electric power supply 9 is electrically connected to the driver 4. The discharging switch 8 is electrically connected to the electric power storage device 7 and the electric power supply 9. The charging switch 6 is electrically connected to the electric power storage device 7. The electric power switch unit 5 is electrically connected to the wire tray unit 31, the charging switch 6 and the electric power supply 9.

The electric power supply 9 is operable to supply a driving electric power to the driver 4 to drive relative rotation of the wire tray unit 31 and the magnetic plate unit 32 such that the wire tray unit 31 generates the electric power induced by the relative rotation of the wire tray unit 31 and the magnetic plate unit 32.

The electric power switch unit 5 is operable to switch between a first mode and a second mode.

In the first mode, the electric power switch unit 5 supplies the electric power generated by the wire tray unit 31 to the charging switch 6 such that the charging switch 6 transmits the electric power to the electric power storage device 7 so that the electric power storage device 7 stores the electric power. In addition, in the first mode, the electric power switch unit 5 controls the discharging switch 8 to transmit the electric power stored in the electric power storage device 7 to the electric power supply so that the electric power supply 9 supplies the driving electric power to the driver 4.

In the second mode, the electric power switch unit 5 controls the discharging switch 8 to stop supplying the electric power stored in the electric power storage device 7 to the electric power supply 9. Moreover, in the second mode, the electric power switch unit 5 transmits a portion of the electric power (hereinafter referred to as first electric power) generated by the wire tray unit 31 to the electric power supply 9 and another portion of the electric power (hereinafter referred to as second electric power) generated by the wire tray unit 31 to the charging switch 6.

Specifically, the electric power switch 5 includes a meter 51, an electric power switch 52 and an electric power distributor 53.

The meter 51 is electrically connected to the electric generator 3 to measure the relative rotation of the wire tray unit 31 and the magnetic plate unit 32, and to generate an output signal. The electric power switch 52 is electrically connected to the meter 51 for receiving the output signal and is operable to switch the electric power switch unit 5 between the first mode and the second mode. The electric power distributor 53 is electrically connected to the electric power switch 52, the charging switch 6 and the electric power supply 9.

When the speed of the relative rotation is smaller than or equal to a predetermined rotational speed, the electric power switch unit 5 is switched to the first mode, where the electric power distributor 53 transmits all of the electric power generated by the wire tray unit 31 to the charging switch 6 and controls the discharging switch 8 to operate.

When the speed of the relative rotation is larger than the predetermined rotational speed, the electric power switch unit 5 is switched to the second mode, where the electric power distributor 53 transmits the first electric power to the electric power supply 9 and the second electric power to the charging switch 6, and controls the discharging switch 8 to stop operating.

Before transmitting the electric power to the electric power storage device 7, the charging switch 6 is also capable of processing, such as filtering and/or voltage regulating, the electric power transmitted thereto by the electric power distributor 53.

During operation of the discharging switch 8, at least a portion of the electric power stored in the electric power storage device 7 is received by the discharging switch 8, and the discharging switch 8 transmits a third electric power to the electric power supply 9. In this embodiment, the third electric power is larger than the first electric power.

The electric power supply 9 is provided with a rechargeable battery that is capable of storing or discharging electric power supplied thereto. The electric power supply 9 is also capable of processing the electric power stored therein, such as transferring a direct current into an alternating current.

When the electric generating system is in operation, the electric power supply 9 is operated to supply the driving electric power to the driver 4. At the same time, the meter 51 is operated to measure the relative rotation of the wire tray unit 31 and the magnetic plate unit 32.

At the beginning of the operation of the electric generating system, the speed of the relative rotation is smaller than the predetermined rotational speed, and therefore the resistance for driving rotation of the magnetic plates 321 is large. As a result, a large amount of electric power is needed for the driver 4 to drive rotation of the transmission shaft 33. It may be beneficial to switch the electric power switch unit 5 to the first mode such that all of the electric power generated by the wire tray unit 31 is transmitted to the charging switch 6, thereby providing sufficient electric power to allow the driver 4 to drive rotation of the transmission shaft 33.

When the speed of the relative rotation is larger than the predetermined rotational speed, the resistance for driving rotation of the magnetic plates 321 is smaller. It may be beneficial to switch the electric power switch unit 5 to the second mode such that: operation of the discharging switch 8 is stopped, the electric power supply 9 is provided with the first electric power; and the charging switch 6 is simultaneously provided with the second electric power, thereby fully utilizing the electric power generated by the wire tray unit 31.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An electric generating system comprising:
an electric generator including a wire tray unit and a magnetic plate unit;
a driver connected to said electric generator;
an electric power supply electrically connected to said driver;
an electric power storage device;
a discharging switch electrically connected to said electric power storage device and said electric power supply;
a charging switch electrically connected to said electric power storage device; and
an electric power switch unit electrically connected to said wire tray unit, said charging switch and said electric power supply,
wherein said electric power supply is operable to supply a driving electric power to said driver to drive relative rotation of said wire tray unit and said magnetic plate unit such that said wire tray unit generates an electric power induced by the relative rotation of said wire tray unit and said magnetic plate unit, and
wherein said electric power switch unit is operable to switch between
a first mode, where said electric power switch unit supplies the electric power generated by said wire tray unit to said charging switch such that said charging switch transmits the electric power to said electric power storage device so that said electric power storage device stores the electric power, and where said electric power switch unit controls said discharging switch to transmit the electric power stored in the electric power storage device to said electric power supply so that said electric power supply supplies the driving electric power to said driver, and
a second mode, where said electric power switch unit controls said discharging switch to stop supplying the electric power stored in the electric power storage device to said electric power supply, and where electric power switch unit transmits a portion of the electric power generated by said wire tray unit to said electric power supply and another portion of the electric power generated by said wire tray unit to said charging switch.

2. The electric generating system as claimed in claim 1, wherein:
said electric power switch unit includes
a meter electrically connected to said electric generator to measure the relative rotation of said wire tray unit and said magnetic plate unit and generate an output signal,
an electric power switch electrically connected to said meter for receiving the output signal and being operable to switch said electric power switch unit between the first mode and the second mode, and
an electric power distributor electrically connected to said electric power switch, said charging switch and said electric power supply;
when the speed of the relative rotation is smaller than or equal to a predetermined rotational speed, said electric power switch unit is switched to the first mode;
when the speed of the relative rotation is larger than the predetermined rotational speed, said electric power switch unit is switched to the second mode;
when said electric power switch unit is switched to the first mode, said electric power distributor transmits all of the electric power generated by said wire tray unit to said charging switch; and
when said electric power switch unit is switched to the second mode, said electric power distributor transmits the electric power generated by said wire tray unit to said electric power supply and said charging switch.

3. The electric generating system as claimed in claim 1, wherein said electric generator further includes a transmission shaft extending along an axis and being co-rotatably connected to said magnetic plate unit, said driver being connected to said transmission shaft and being operable to drive rotation of said transmission shaft.

4. The electric generating system as claimed in claim 3, wherein said magnetic plate unit includes at least one magnetic plate that is co-rotatably connected to said transmission shaft and that includes a plurality of magnets disposed around the axis.

5. The electric generating system as claimed in claim 4, wherein said wire tray unit includes two wire trays respectively disposed at opposite sides of said magnetic plate of said magnetic plate unit.

6. The electric generating system as claimed in claim 4, wherein said magnetic plate unit includes a plurality of said magnetic plates co-rotatably connected to said transmission shaft, said wire tray unit including a plurality of said wire trays, said magnetic plates and said wire trays being alternatively arranged along the axis.
